(19) United States
(12) Patent Application Publication
(10) Pub. No.: US 2016/0047167 A1
(43) Pub. Date: Feb. 18, 2016

(54) MOBILE LIFELINE LADDER SYSTEM

(71) Applicant: ALTISEG EQUIPAMENTOS DE SEGURANCA DE TRABALHO LTDA-EPP, Curitiba (BR)

(72) Inventors: Daniel Shuch, Curitiba (BR); Luis Eduardo Vicente Catta-Preta, Curitiba (BR); Nelson Pudles, Curitiba (BR)

(21) Appl. No.: 14/823,628

(22) Filed: Aug. 11, 2015

Related U.S. Application Data
(60) Provisional application No. 62/036,871, filed on Aug. 13, 2014.

(51) Int. Cl. E06C 7/18; A62B 1/06

(52) U.S. Cl. CPC E06C 7/187; A62B 1/06

(57) ABSTRACT

A mobile lifeline ladder system is provided. The mobile lifeline ladder system includes a lifeline, a lifeline supply assembly, a rescue assembly and an anchor assembly. The lifeline has a first portion, a second portion and an intermediate portion that is positioned between the first portion and the second portion. The lifeline supply assembly contains the first portion of the lifeline. The lifeline supply assembly is configured and arranged to be coupled to a ladder. The rescue assembly contains the second portion of the lifeline. The rescue assembly is configured and arranged to be coupled to a first support structure. The rescue assembly includes a lifeline payout regulator to selectively payout the second portion of the lifeline. The anchor assembly is configured and arranged to be coupled to a second support structure above the ladder. The intermediate portion of the lifeline is slidably held by the anchor assembly.

### CROSS-REFERENCE TO RELATED APPLICATIONS

This Application claims priority to U.S. Provisional Application Ser. No. 62/036,871, same title herewith, filed on Aug. 13, 2014, which is incorporated in its entirety herein by reference.

### BACKGROUND

Fall protection systems that protect workers are used in work locations where a fall could cause injury or death. A typical fall protection system includes a safety harness that is donned by the worker, a lifeline that is attached to the harness, and a support structure to which the lifeline is connected. This system works well in typical situations where a stationary stable support structure is available for attachment. However, with portable climbing systems, such as a ladder, a support structure is not always available.

For the reasons stated above and for other reasons stated below which will become apparent to those skilled in the art upon reading and understanding the present specification, there is a need in the art for an effective and efficient mobile lifeline ladder system.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a mobile lifeline ladder system is provided. The mobile lifeline ladder system includes a lifeline, a lifeline supply assembly, a rescue assembly and an anchor assembly. The lifeline has a first portion, a second portion and an intermediate portion that is positioned between the first portion and the second portion. The lifeline supply assembly contains the first portion of the lifeline. The lifeline supply assembly is configured and arranged to be coupled to a ladder. The rescue assembly contains the second portion of the lifeline. The rescue assembly is configured and arranged to be coupled to a first support structure. The rescue assembly includes a lifeline payout regulator to selectively payout the second portion of the lifeline. The anchor assembly is configured and arranged to be coupled to a second support structure above the ladder. The intermediate portion of the lifeline is slidably held by the anchor assembly.

In another embodiment, another mobile lifeline ladder system is provided. The mobile lifeline ladder system includes a lifeline, a rescue assembly, an anchor assembly and a lifeline supply assembly. The lifeline has a first portion, a second portion and an intermediate portion that is positioned between the first portion and the second portion. The rescue assembly contains the second portion of the lifeline. The rescue assembly is configured and arranged to be coupled to a first support structure. Moreover, the rescue assembly includes a lifeline payout regulator that selectively pays out the second portion of the lifeline. The anchor assembly is configured and arranged to be coupled to a second support structure above a ladder. The intermediate portion of the lifeline is slidably held by the anchor assembly. The lifeline supply assembly includes a main housing member. The main housing member is configured and arranged to contain the lifeline, the rescue assembly and the anchor assembly during transit. The main housing is further configured and arranged to be coupled to the ladder during use while housing the first portion of the lifeline

In yet another embodiment, a method of implementing a lifeline ladder system is provided. The method includes, coupling a main housing member of a lifeline supply assembly to a ladder proximate a base portion of the ladder. A support anchor assembly is coupled to a first support structure above the ladder. The support anchor includes a routing member. A rescue assembly is coupled to a second support structure near the base portion of the ladder. The rescue assembly includes a lifeline payout regulator. A lifeline is routed from the main housing, through the routing member of the support anchor and to the rescue assembly. A rope grab that is connected to a safety harness donned by a worker is attached to the lifeline.

### BRIEF DESCRIPTION OF THE DRAWINGS

The present invention can be more easily understood and further advantages and uses thereof will be more readily apparent, when considered in view of the detailed description and the following figures in which:

FIG. 1 is a side perspective view of a deployed mobile lifeline ladder system of one embodiment of the present invention;

FIG. 2 is a front perspective view of a lifeline support assembly of the mobile lifeline ladder system of FIG. 1;

FIG. 3A is a side view of a rescue assembly of the mobile lifeline ladder system of FIG. 1;

FIG. 3B is a first side view of a lifeline payout regulator of one embodiment of the present invention;

FIG. 3C is a second side view of the lifeline payout regulator of FIG. 3B;

FIG. 4 is a side view of a portion of a ladder stabilizing assembly of the mobile lifeline ladder system of FIG. 1;

FIGS. 5A and 5B are side views of an unassembled ladder anchor assembly of the mobile lifeline ladder system of FIG. 1;

FIG. 6A is a side view of a buckle strap of one embodiment of the present application;

FIG. 6B is a side view of a control strap of one embodiment of the present invention;

FIG. 7 is a side view of an upper anchor assembly of the mobile lifeline ladder assembly of FIG. 1;

FIG. 8A is a side view of an upper anchor assembly of another embodiment of the present invention;

FIG. 8B is an illustration of the upper anchor assembly of FIG. 8A in use;

FIG. 9 illustrates the connection of the lifeline supply assembly to a ladder in one embodiment of the present invention;

FIG. 10 illustrates the opening of a main housing member of the lifeline supply assembly;

FIG. 11 illustrates the removal of the rescue assembly from the main housing member of the lifeline supply assembly;

FIGS. 12-13 illustrate the attachment of a ladder anchor assembly to a rung of a ladder;

FIG. 14 illustrates the positioning of the rescue assembly through the ladder;

FIG. 15 illustrates the attachment of a middle portion of a lifeline to the ladder anchor assembly;

FIG. 16 is an illustration of a user moving the rescue assembly down the backside of the ladder;

FIGS. 17 and 18 are illustrations of a control strap being coupled to the lifeline and a ladder rung;

FIGS. 19 though 21 illustrate a temporary connection of the rescue assembly to the ladder;

FIGS. 22 through 24 illustrate the attachment of the ladder stabilizer assembly to the ladder;

FIGS. 25 through 26 illustrate the positioning of a ladder on a support structure;

FIGS. 27 through 29 illustrate the deployment of the ladder stabilizing assembly to the support structure;

FIGS. 30-32 illustrate the attachment of the rescue assembly to the support structure;

FIG. 33 illustrates a user taking up slack in the lifeline before a climb;

FIG. 34 illustrates a climbing worker attaching a safety harness to the lifeline;

FIG. 35 illustrates the climbing worker climbing the ladder;

FIGS. 36 and 37 illustrate the attachment of the upper anchor assembly to the support structure;

FIGS. 38 and 39 illustrate the attaching of the lifeline to the upper anchor assembly;

FIG. 40 illustrates the climbing worker experiencing a fall event; and

FIGS. 41-45 illustrate a rescue worker manipulating the portable mobile lifeline system to rescue the climbing worker.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

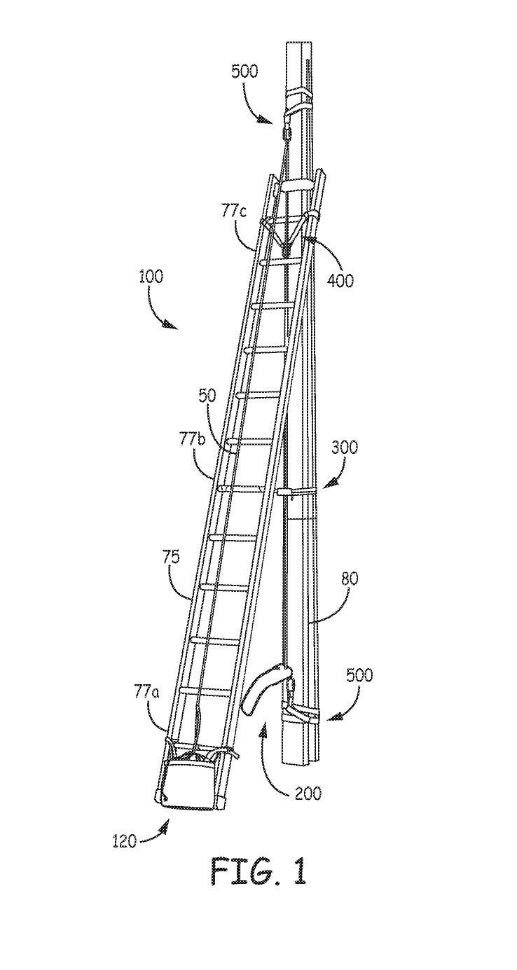

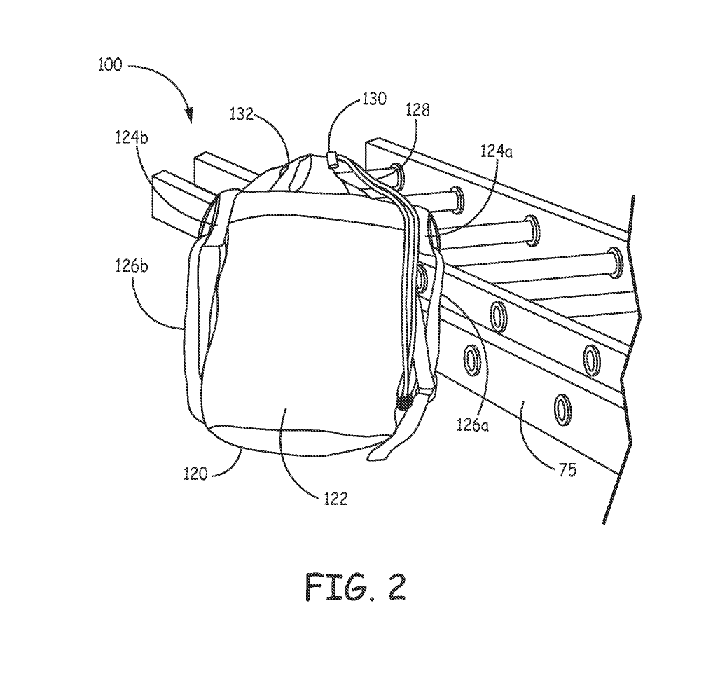

Embodiments of the present invention provide a mobile lifeline ladder system 100 for a ladder 75 as generally illustrated in FIG. 1. The mobile lifeline ladder system 100 is easily transported to the location of use in a main housing member 122 of a lifeline supply assembly 120. The mobile lifeline ladder system 100 includes the lifeline supply assembly 120, a lifeline 50, a rescue assembly 200, a ladder stabilizing assembly 300, a ladder anchor assembly 400 and a support anchor assembly 500. The mobile lifeline ladder system 100, when deployed, is coupled to a ladder 75 and a support 80, such as a vertically extending pole as illustrated in FIG. 1. The ladder 75 is illustrated as having a base portion 77a, a mid-portion 77b and an upper portion 77c. As illustrated in FIG. 1, the lifeline supply assembly 120 is coupled to the ladder 75 proximate the base portion 77a of the ladder 75. The ladder anchor assembly 400 is coupled to the ladder 75 proximate the upper portion 77c of the ladder 75. The ladder stabilizing assembly 300 is coupled to the ladder 75 proximate the mid-portion 77b of the ladder 75. Although the support 80 is illustrated as a pole, any type of support structure or multiple support structures can be used. Hence, for example, the support structure 80 may be a first support structure, a second different support structure and a third different support structure. Referring to FIG. 2, a close up of the main housing member 122 of the lifeline supply assembly 120 is illustrated. The main housing member 122 of the lifeline supply assembly 120 is, in one embodiment, a bag or pouch that is made of a fabric. The main housing member 122, in the embodiment illustrated in FIG. 2, includes an access portion 132 which has an opening that is opened and closed with a draw string arrangement. The draw string arrangement includes a draw string 128 that is threaded around an opening in the access portion 132 and a draw string lock 130 which selectively locks a position of the draw string 128 in relation to the access portion 132 to selectively close or open the opening to the access portion 132. In one embodiment, within the lifeline supply assembly 120, all of the elements of the portable mobile lifeline system 100 are housed for storage and transportation. Connected to the main housing member 122 are housing connection loops 124a and 124b. The main housing member 122 is coupled to a ladder 75 via the housing connection loops 124a and 124b and respective main housing connecting straps 126a and 126b as further discussed below.

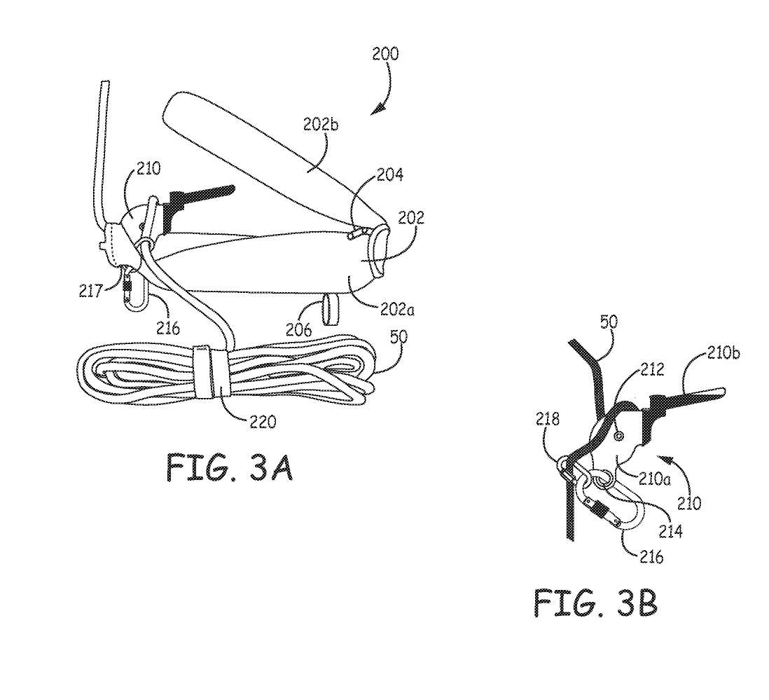

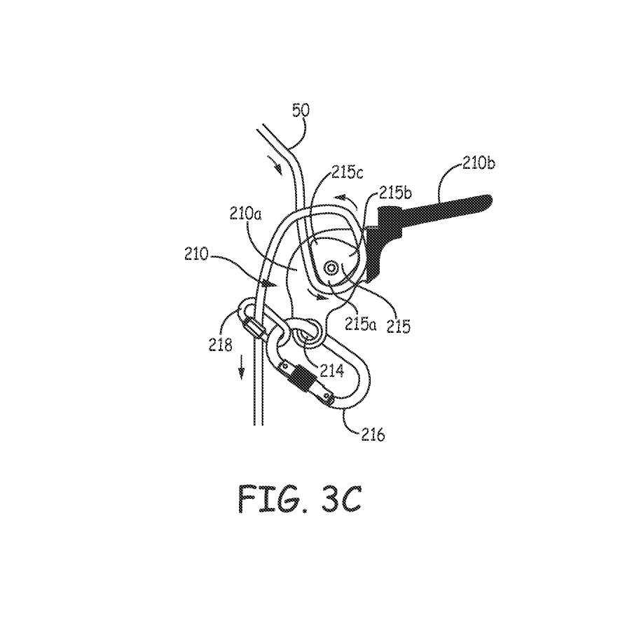

FIG. 3A is a side view of the rescue assembly 200. The rescue assembly 200 includes a rescue case 202 that has a first portion 202a and a second portion 202b. A zipper 204 selectively opens and shuts an opening in the rescue case 202. Within the case 202 is contained a portion of the lifeline 50 and a lifeline payout regulator 210. The portion of the lifeline 50 within the case 202 can be held in a compact state via strap 220. A close up first side view of the lifeline payout regulator 210 is illustrated in FIG. 3B. The lifeline payout regulator 210 includes a base portion 210a and a handle portion 210b which extends from the base portion 210a. The handle portion 210b is used to grasp during a rescue situation as further described below. A fastener 212 is used to fasten a lock member 215. The lock member 215 is attached to a surface of the base portion as illustrated in the second side view of the lifeline payout regulator 210 in FIG. 3C. The lifeline 50 is routed around the lock member 215. The lock member 215 in this embodiment includes corners 215a, 215b and 215c that prevent the lifeline from sliding around the lock member 215 during a fall event. The lifeline payout regulator 210 further includes a connection aperture 214. A carabiner 216 is coupled to the lifeline payout regulator 210 via the connection aperture 214. A quick connect link 218 is in turn coupled to the carabiner 216. The lifeline 50 is routed through the quick connect link 218. As illustrated in FIG. 3A the carabiner 216 extends through a carabiner opening 217 in the rescue case 202. Extending from the case 202 is a connection loop 206. The function of the connection loop 206 is further discussed below.

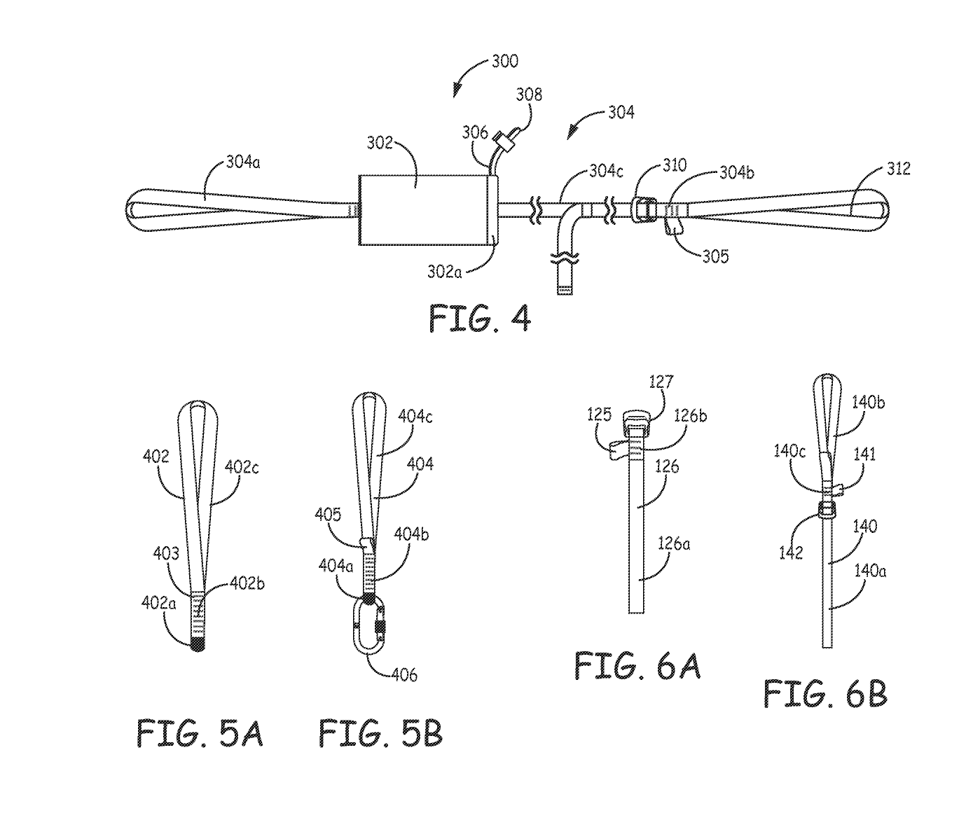

Referring to FIG. 4, the ladder stabilizing assembly 300 is illustrated. The ladder stabilizing assembly 300 includes a stabilizing case 302. The stabilizing case 302 holds at least a portion of a connecting strap assembly 304 until use. The connecting strap assembly 304 includes a first portion 304a, a second portion 304b and a third portion 304c. The second portion 304b includes a connection loop 312 and buckle 310. The stabilizing case 302 in this embodiment includes an opening portion 302a. A draw string 306 engages the opening portion 302a of the stabilizing case 302 to selectively open and close an opening to the case 302. A draw string lock 308 can be used to lock the draw string 306 in relation to the opening portion 302a of the case 302 to keep the opening to the case 302 closed. The second portion 304b and third portions 304c can be stored within the case 302 when not in use. The buckle 310 is used to adjust the length of the second portion 304b of the connection strap assembly 304 in relation to the third portion 304c. A label 305 is used in one embodiment to identify the part for assembly. Further discussion of the ladder stabilizing assembly 300 is provided below.

FIGS. 5A and 5B illustrate the ladder anchor assembly 400. The ladder anchor assembly 400 includes a first anchor strap portion 402 and a second anchor strap portion 404. The first anchor strap portion 402 includes a holding loop portion 402a and a connection looped portion 402c. Between the holding loop portion 402a and the connection looped portion 402c is a connected portion 402b. In one embodiment the first anchor strap portion 402 is made from a strap that is folded back on itself and connected by stitching 403 to form the holding loop portion 402a, the connection portion 402b and the connection looped portion 402c. The connection looped portion 402c is connected to a portion of a ladder as discussed further below. The second anchor strap portion 404 is similar to the first anchor strap portion 402 including a holding loop portion 404a, a connection portion 404b and a connection looped portion 404c. A carabiner 406 is connected to the holding loop portion 404a. The second anchor strap portion 404 includes label 405 that in one embodiment provides instructions on its operation. The connection looped portion 404c of the second anchor strap portion 404 is connected to another portion of the ladder. Then the carabiner 406 is attached to the holding loop portion 402a of the first anchor strap portion 402 to form the ladder anchor assembly 400 as is further discussed below.

FIG. 6A illustrates a buckle strap 126. The buckle strap 126 is used to couple the main housing member 122 to the ladder 75 as further discussed below. The buckle strap 126 includes a strap portion 126a that is coupled to a buckle 127 via connection portion 126b. The connection portion 126b in this embodiment is formed via an end section of the strap portion 126b passing through a portion of the buckle 127 and being folded back on itself and being coupled via stitching. The embodiment of FIG. 6A of the buckle strap 126 also includes tag 125 that is used to provide information such as, but not limited to, instructions on the use of the buckle strap 126. FIG. 6B illustrates a control strap 140 that is coupled to the ladder 75, as discussed below, to control the payout of the lifeline 50. The control strap 140 includes a strap portion 140a and a looped portion 140b. In the embodiment shown, the looped portion 140b is formed via coupling portion 140c that is an end of the looped portion 140b coupled to the strap portion 140a via stitching. Also included in this embodiment is a control buckle 142 that is coupled proximate the coupling portion 140c. An end of the strap portion 140 is selectively attached to the buckle 142 to engage the lifeline 50 as the loop portion 140b is coupled to a rung of the ladder as described further below. This embodiment of the control strap 140 includes a tab 141 that provides information such as, but not limited to, instructions on the use of the control strap 140.

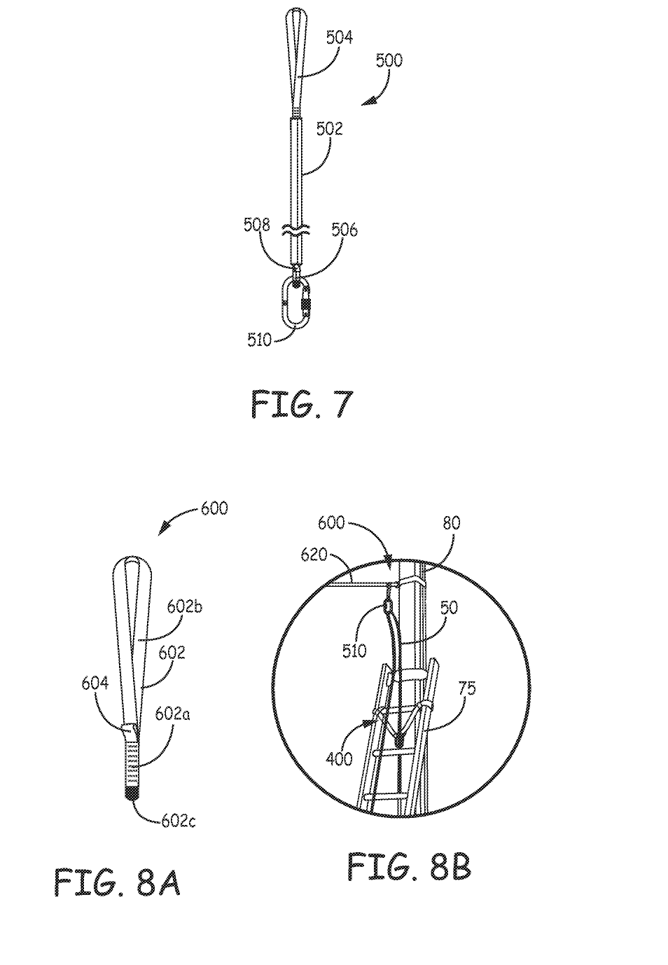

Referring to FIG. 7 an example embodiment of the support anchor assembly 500 is illustrated. The support anchor assembly 500 in this embodiment includes a main strap portion 502. Coupled to one end of the main strap portion 502 is a connection loop portion 504 which is designed to be coupled to a support structure, such as support structure 80 in FIG. 1. Coupled to another end of the main strap portion 502 is a carabiner connection portion 506 that is designed to receive a carabiner 510. The carabiner 510 is used to hold and route the lifeline 50 once the upper anchor assembly 500 is coupled to the support structure 80. This embodiment of the support anchor assembly 500 also includes a tag 508 used to convey information such as, but not limited to, instructions for use of the support anchor assembly 500. In an alternative embodiment, where a support lifeline 620 (illustrated in FIG. 8B) is available, an alternative support anchor assembly 600 is used. This support anchor assembly 600 is illustrated in FIG. 8A. The support anchor assembly 600 includes an auxiliary connection strap 602 including a strap portion 602a that is positioned between a looped portion 602b and a carabiner holding portion 602c. In one embodiment, the support anchor assembly 600 is formed with a single strap that has a portion folded back on itself with selective stitching. The embodiment illustrated in FIG. 8A further includes a tab 604 used to convey information such as, but not limited to, instructions for use of this support anchor assembly 600. The support anchor assembly 600 in use is illustrated in FIG. 8B. As discussed above, this support anchor assembly 600 embodiment is used when a support lifeline 620 is available. The carabiner 510 is coupled directly to the support anchor assembly 600 to route the lifeline 50. Hence, the support anchor assembly 600 provides an upper anchor when working with different types of support structures. Moreover, support anchor assembly 500 provides both an upper anchor and a lower anchor as described further below.

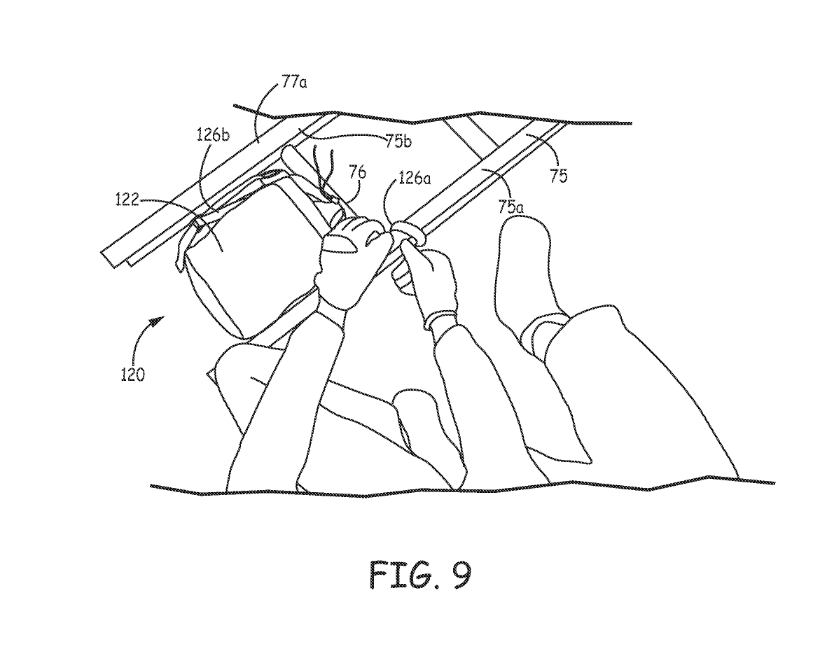

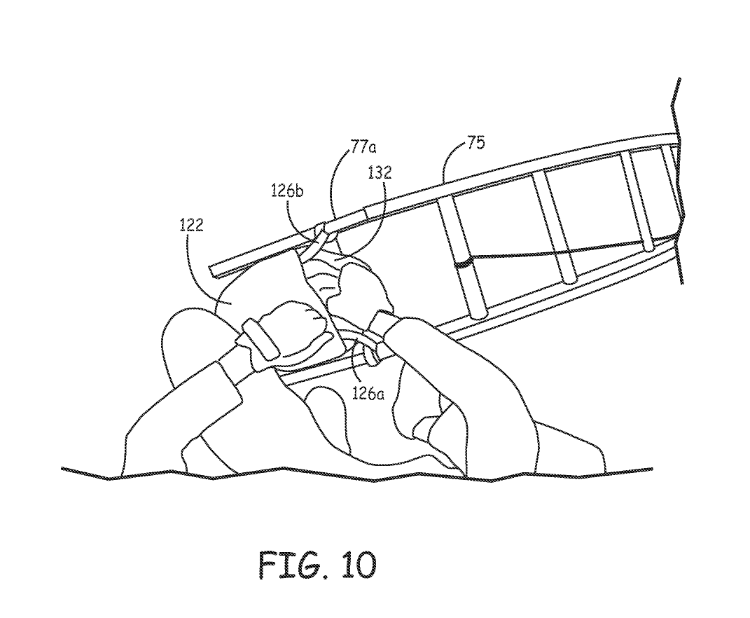

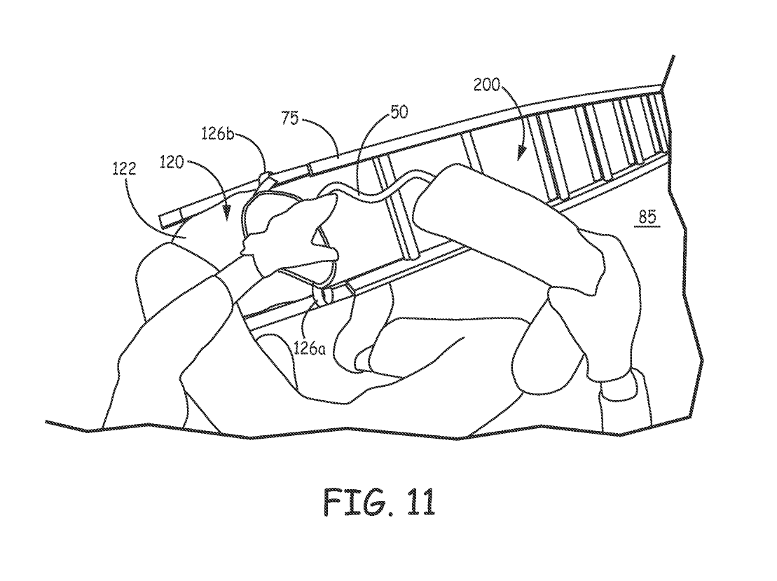

FIGS. 9 through 45 illustrate the implementation and use of the portable mobile lifeline assembly 100. Referring to FIG. 9, the main housing member 122 of the lifeline supply assembly 120 is coupled to the ladder 75 near the base portion 77a of the ladder 75 proximate a first rung 76 of the ladder 75. This is accomplished by coupling the respective main housing connection straps 126a and 126b to the respective housing connection loops 124a and 124b and a respective side rail 75a and 75b of the ladder 75. Once the main housing member 122 is connected to the ladder 75, the access portion 132 of the main housing member 122 is opened, as illustrated in FIG. 10, and the components of the mobile lifeline ladder system 100 are removed. This step can also occur before attaching the main housing member 122 to the ladder 75. FIG. 11 illustrates the removal of the rescue assembly 200 from the main housing member 122. As illustrated, a portion of the lifeline 50 remains in the main housing member 122 and a portion remains in the rescue assembly 200. The rescue assembly 200 is then pulled along the length of the ladder 75 which is positioned on the floor 85.

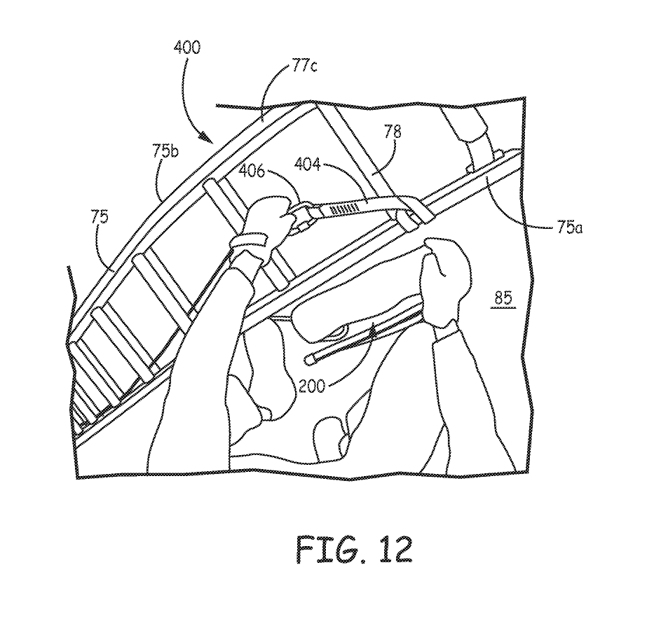

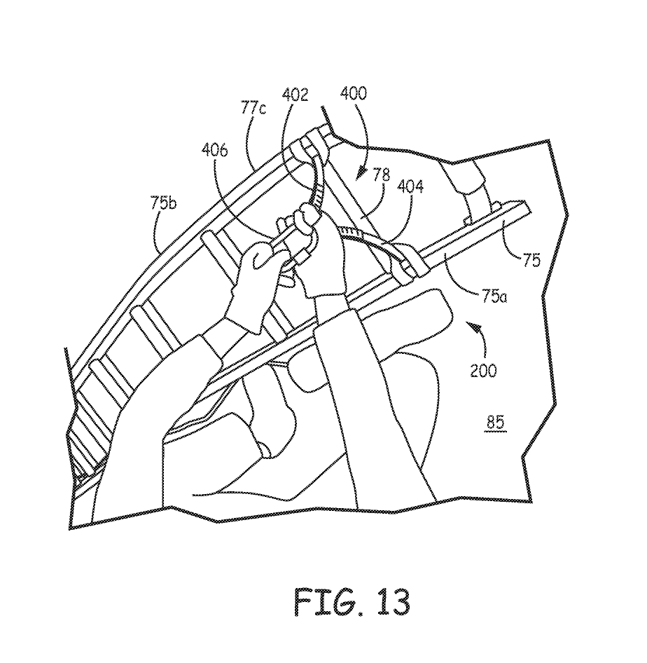

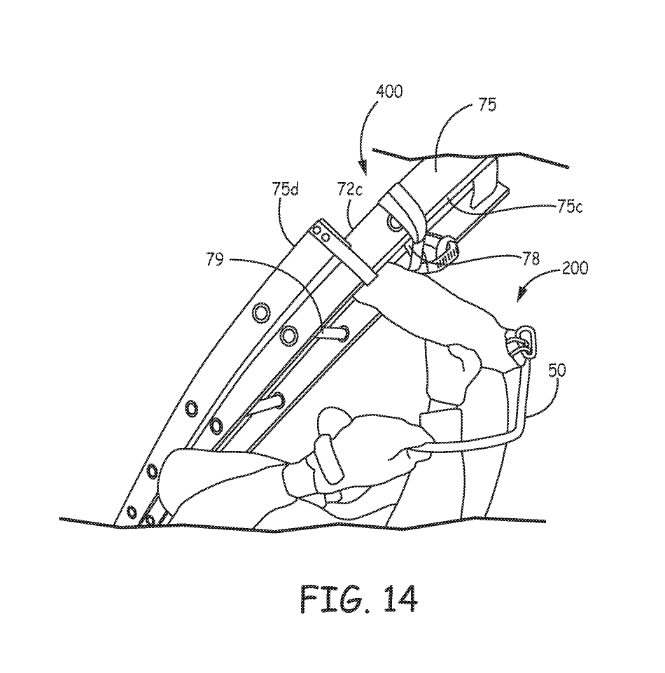

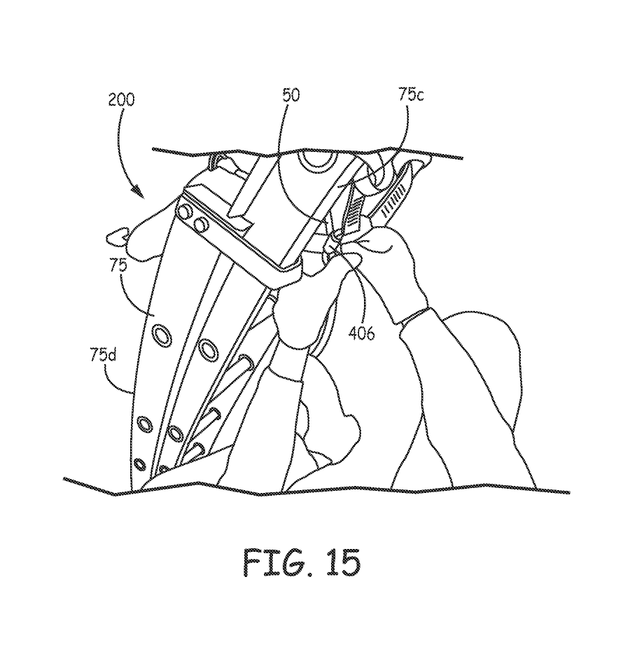

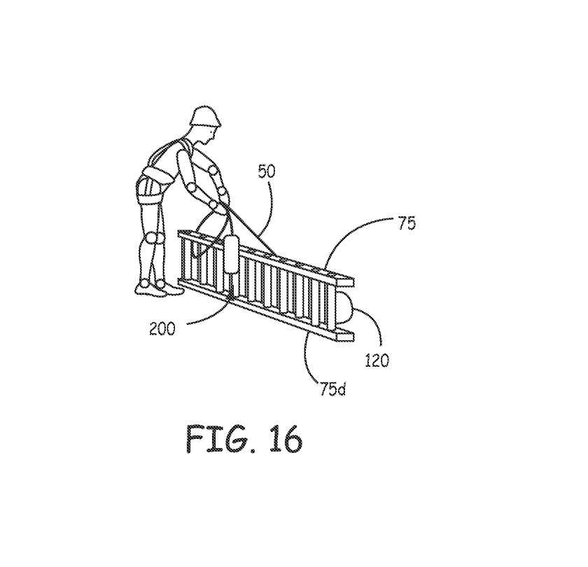

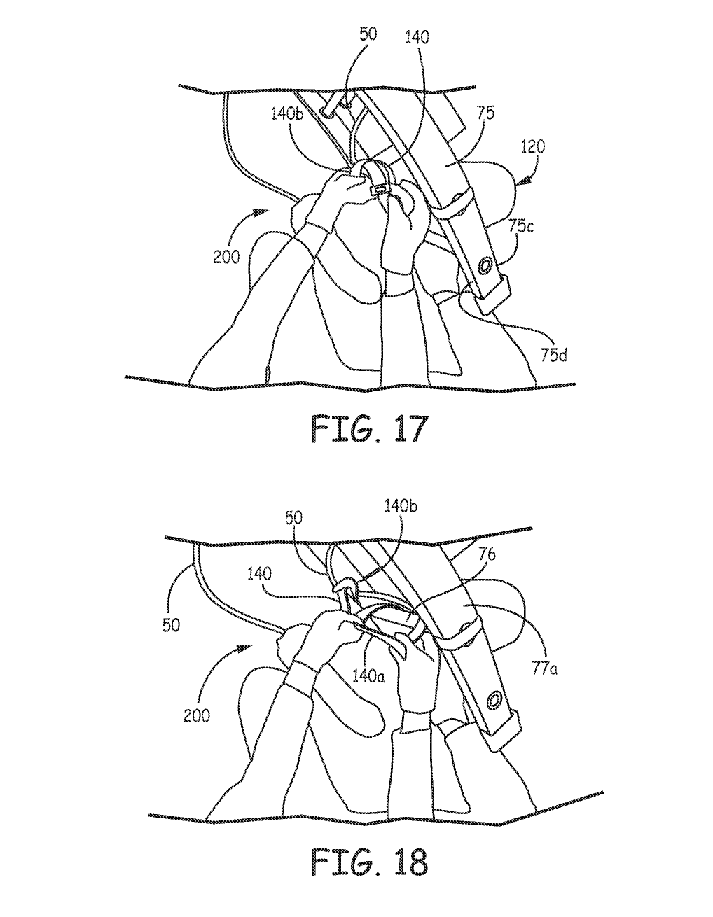

Referring to FIG. 12 the ladder anchor assembly 400 is attached towards the top of the ladder 75 which is positioned on the floor 80. FIG. 13 illustrates the second anchor 404 being coupled to the first rail 75a of the ladder 75 proximate an upper rung 78 of the ladder 75. To attach the second anchor 404, the second anchor 404 is positioned around the first rail 75a of the ladder 75 while threading the carabiner 406 and the connection portion 404b through the holding loop portion 404c. The first anchor 402 is coupled to the second rail 75b of the ladder 75 in a similar manner by placing the first anchor 402 around the second rail 75a of the ladder 75 near the upper rung 78 of the ladder 75 and threading the holding loop portion 402a and the connection portion 402b through the connection looped portion 402c. Once both the first anchor 402 and the second anchor 404 is coupled to the ladder 75, the carabiner 406 that is attached to the second anchor 404 is coupled to the first anchor 402 to form the ladder anchor assembly 400 as illustrated in FIG. 13. The rescue assembly 200 is then passed between rungs 78 and 79 from the front side 75c of the ladder 75 to a backside 75d of the ladder 75 as illustrated in FIG. 14. The carabiner 406 (routing member) of the ladder anchor assembly 400 is then opened and the lifeline 50 is positioned within as illustrated in FIG. 15. The carabiner 406 is then closed to form an initial anchor point of the mobile lifeline ladder system 100. The rescue assembly 200 is then walked down the back side 75d of the ladder, as illustrated in FIG. 16 until it is proximate the lifeline supply assembly 120. The rescue assembly 200 positioned on the back side 75d of the ladder 75 proximate the lifeline supply assembly 120 which is on the front side 75c of the ladder 75 is illustrated in FIG. 17.

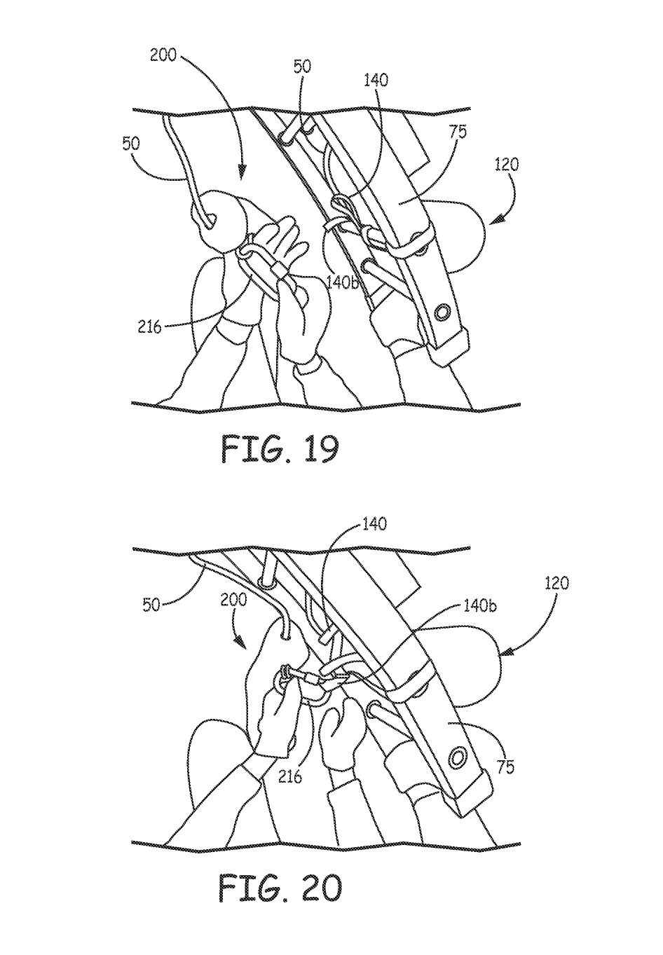

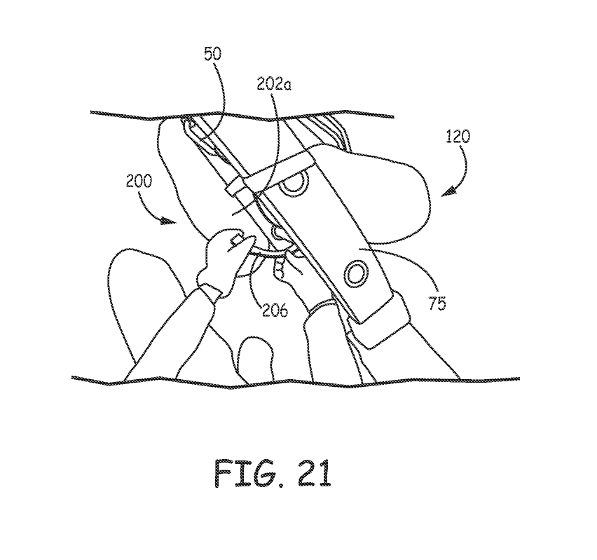

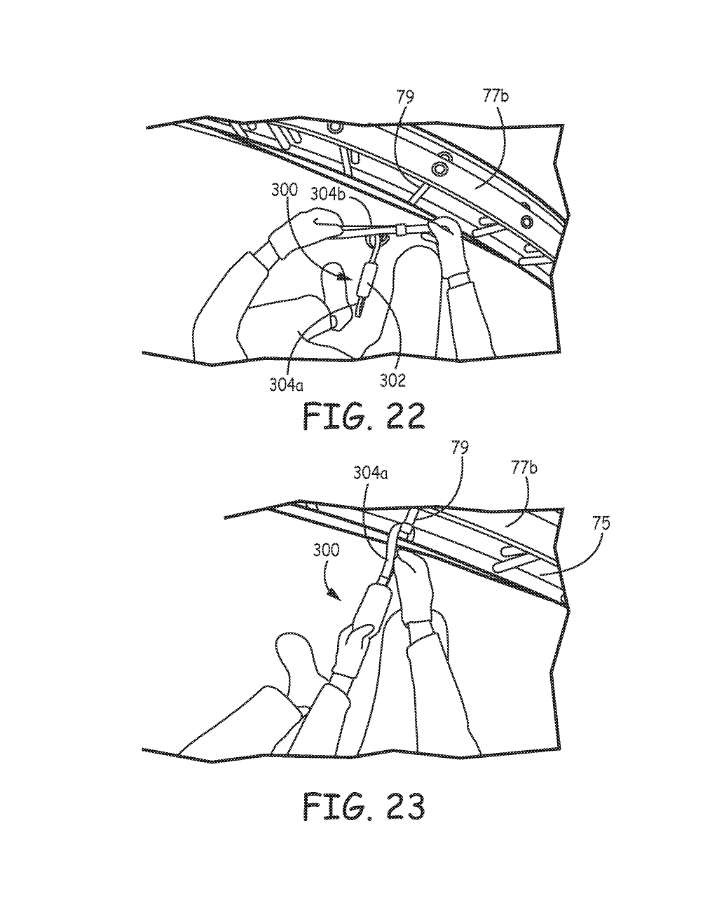

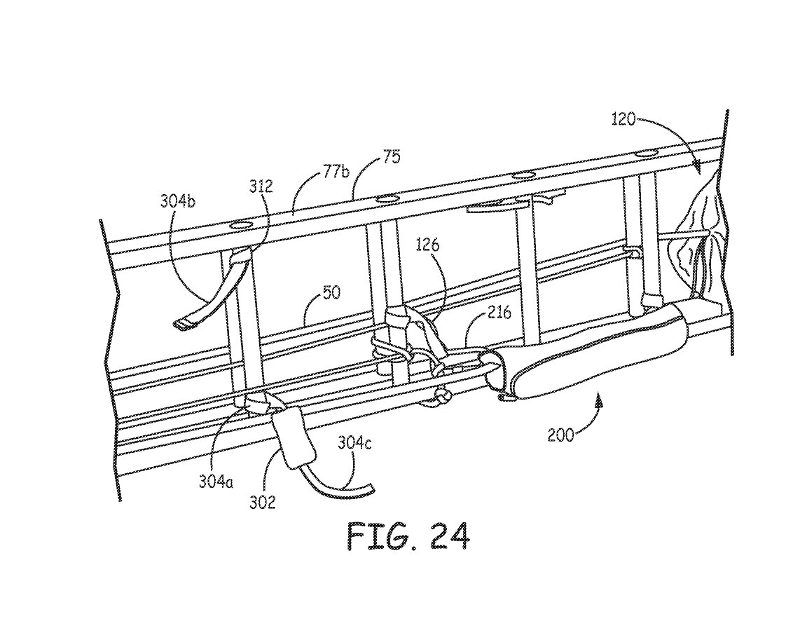

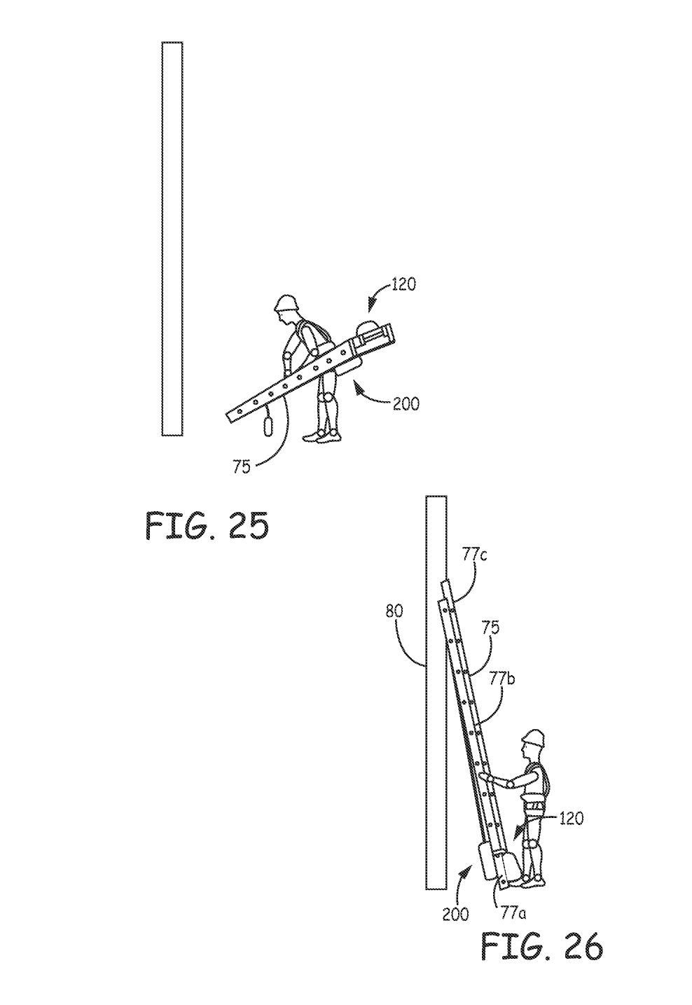

FIGS. 17 and 18 further illustrate the control strap 140 being coupled to the lifeline 50 and the ladder rung 76. In particular in this example, the looped portion 140b is wrapped around the lifeline 50 and the holding strap portion 140a is wrapped around rung 76 of the ladder 75 and coupled to rung 76 with the use of buckle 142. Referring to FIGS. 19 and 20, the carabiner 216 of the rescue assembly 200 is then temporarily coupled to a portion of the control strap 140 to hold the rescue assembly 200 to the ladder 75 while the ladder 75 is set up for use in this example embodiment. Moreover, FIG. 21 illustrates the connection loop 206 of the case 202 of the rescue assembly 200 can also be temporarily coupled to the ladder 75 during deployment positioning of the ladder 75. Prior to deployment of the ladder 75, the ladder stabilizing assembly 300 is attached. This is illustrated in FIGS. 22 and 23. In particular, FIGS. 22 and 23 illustrate the coupling of the second portion 304b and the first portion 304a of the connection strap assembly 304 of the ladder stabilizing assembly 300 to a rung of the ladder 75. An example of this is further seen in FIG. 24. As illustrated, the looped section 312 of the second portion 304b is coupled to one side of rung 79 while the first portion 304a of the connection strap assembly 304 is coupled to another side of rung 79. The embodiment of FIG. 24 further illustrates another way to temporarily coupled the rescue assembly 200 to the ladder 75 during deployment. In this example, a connection strap 126 with a looped section is used to couple the carabiner 216 to a rung and the connection loop 206 of the case 202 is coupled to another spaced rung of the ladder 75. Once the lifeline 50 is properly threaded through the ladder anchor assembly 400 and the lifeline support assembly 120, the rescue assembly 200 and the ladder stabilizing assembly 300 are attached to the ladder 75, the ladder 75 is then picked up and is positioned for use as illustrated in FIGS. 25 and 26. In particular, the ladder 75 is positioned against a support structure 80 in the illustration of FIG. 26.

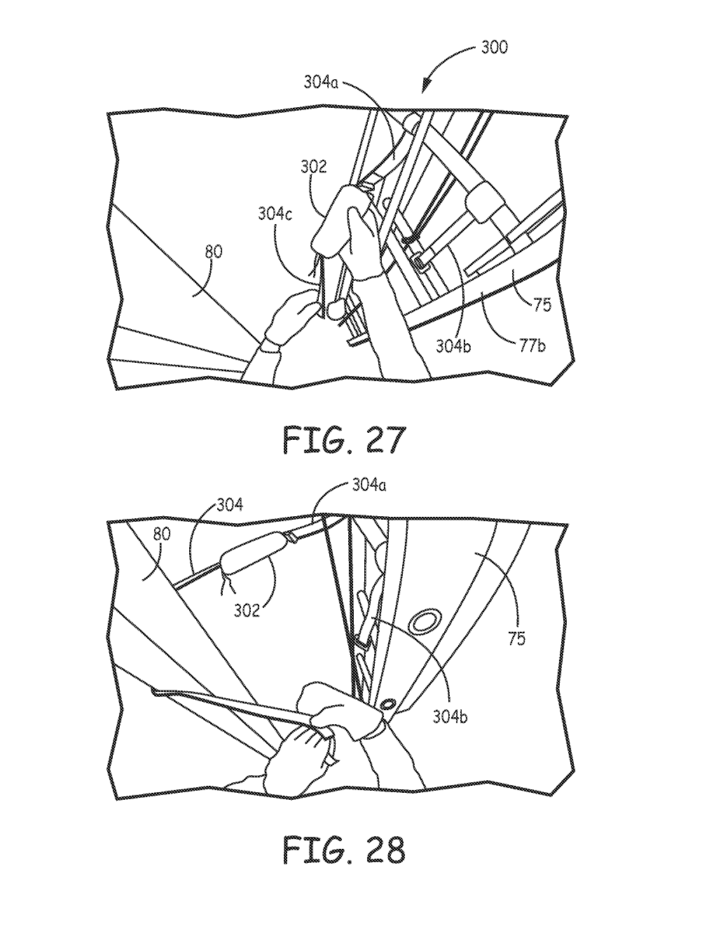

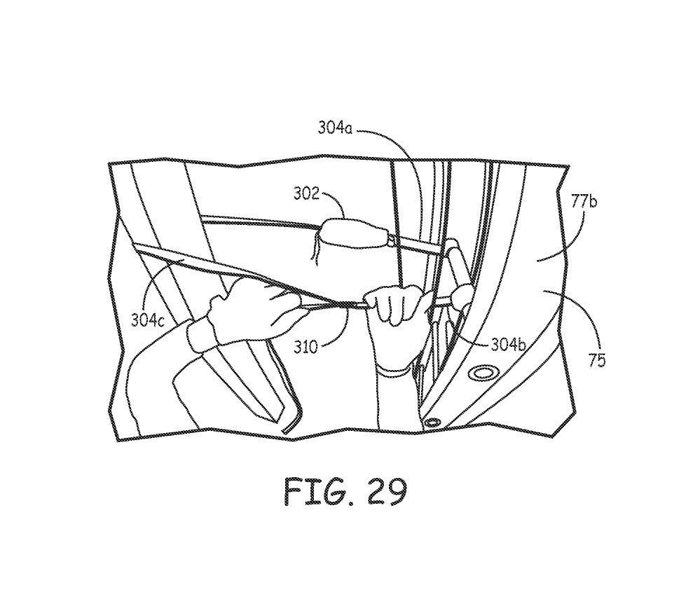

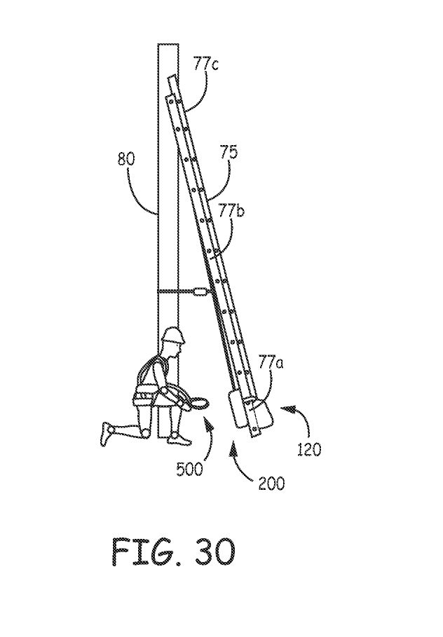

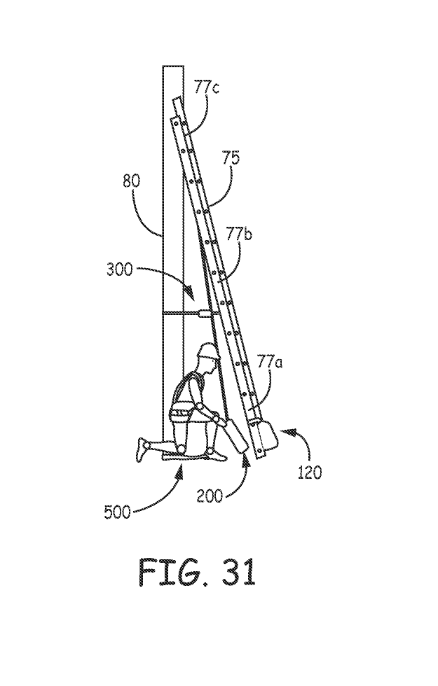

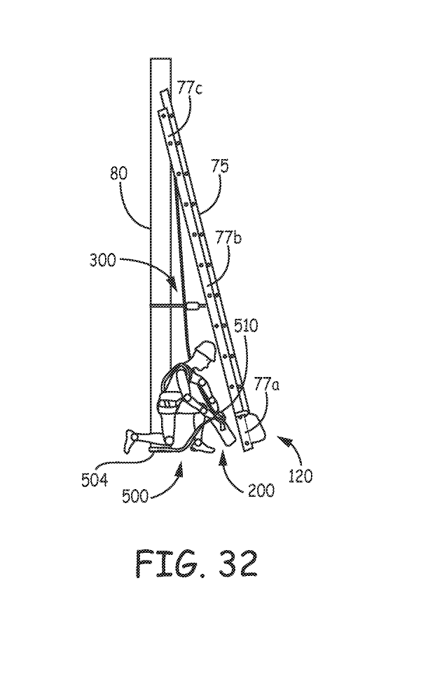

Once the ladder 75 is in position for use, the ladder stabilizing assembly 300 is attached to the support 80. This is illustrated in FIGS. 27-29. In particular, FIG. 27 illustrates the user about to open the opening portion 302a of the stabilizing case 302 to pull out the third portion 304c of the connection strap assembly 304 of the ladder stabilizing assembly 300. FIG. 28 illustrates the positioning of the third portion 304c of the connection strap assembly 304 around the support 80. FIG. 29 illustrates the connecting of the third portion 304c of the connection strap 304 to the second portion 304b via buckle 310 to deploy the stabilizing assembly 300. Once the stabilizing assembly 300 is attached, the rescue assembly 200 is deployed for use. This is first done by attaching a support anchor assembly 500 around a base of the support 80 as illustrated in FIG. 30. The rescue assembly 200 is then detached from the ladder 75 as illustrated in FIG. 31 and is attached to the support anchor assembly 500 as illustrated in FIG. 32.

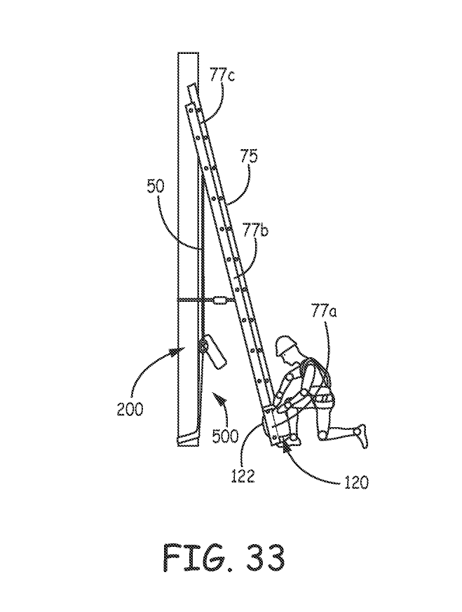

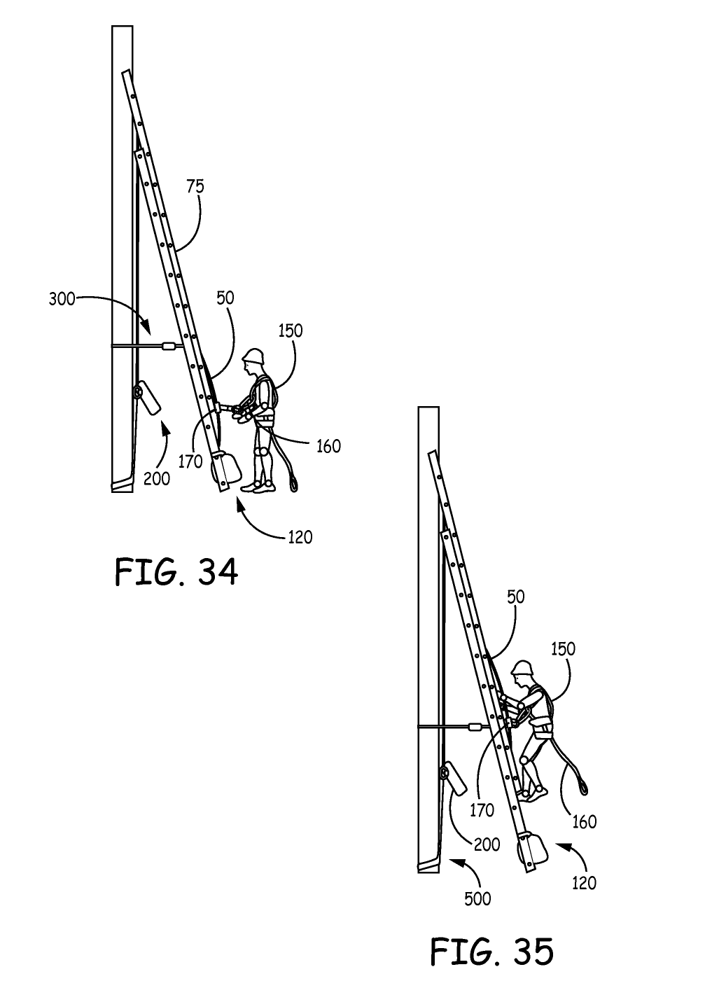

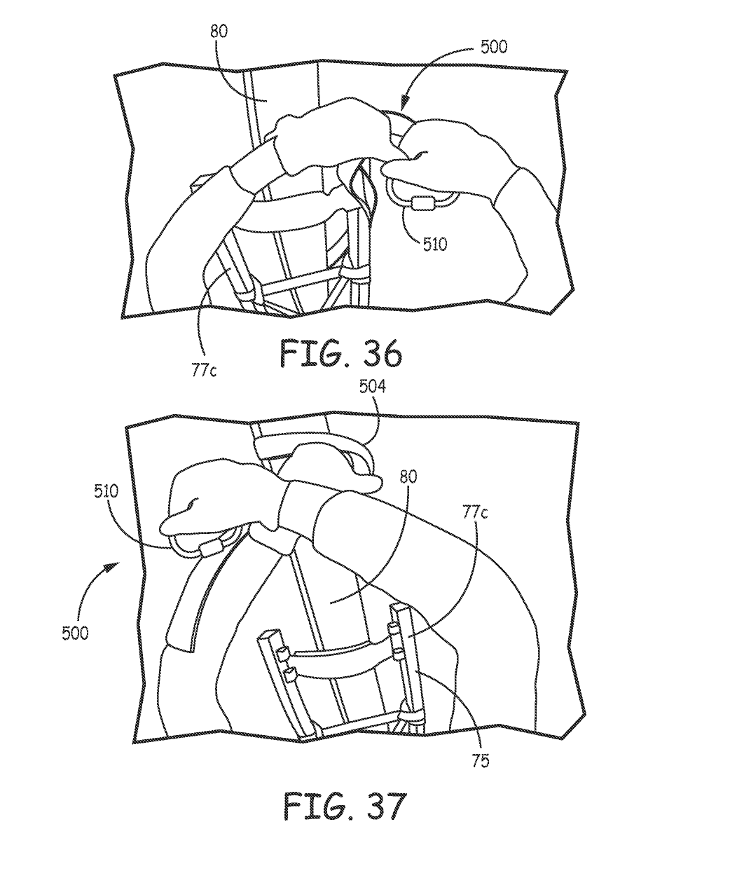

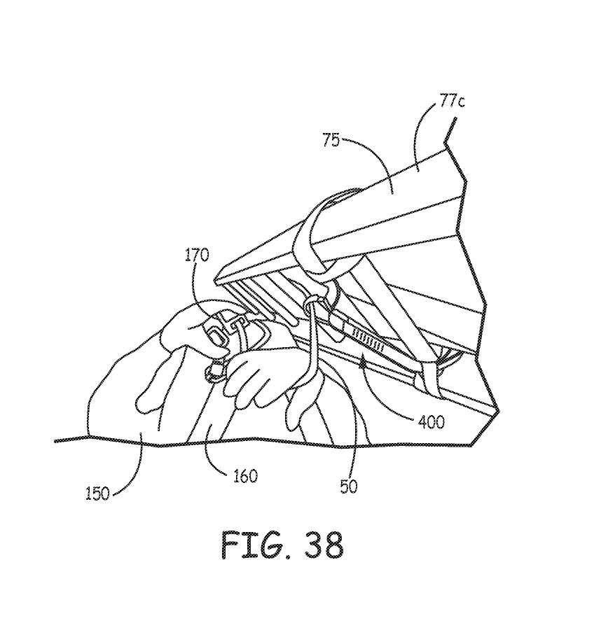

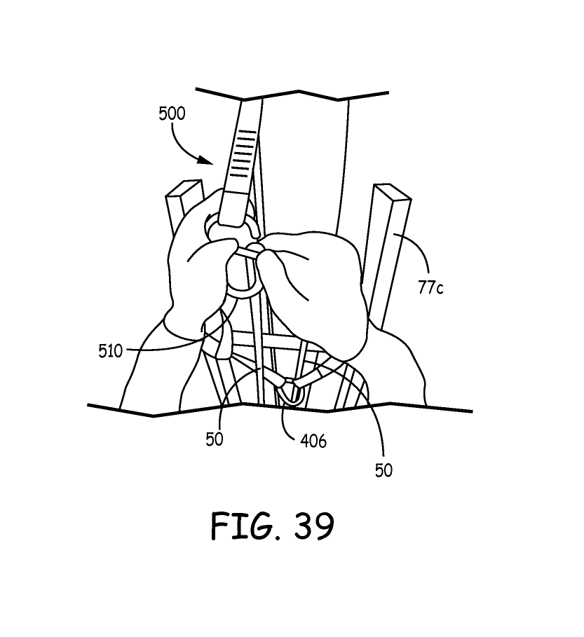

Once the rescue assembly 200 is attached, slack in the lifeline 50 is taken up by pulling the excess lifeline 50 back into the main housing member 122 of a lifeline supply assembly 120 as illustrated in FIG. 33 so the lifeline 50 coming out of the rescue assembly 200 is taunt. A climbing worker 150 donning a safety harness 160 that is attached to a rope grab 170 can then begin to climb the ladder 75. Before climbing, the climbing worker 150 attaches the rope grab 170 to the lifeline 50. This is illustrated in FIG. 34. Once attached, the climbing worker 150 can start ascending the ladder 75 as illustrated in FIG. 35. Once the climbing worker 150 can reach above the ladder 75, the climbing worker 150 attaches a support anchor assembly 500 to the support 80 above the ladder 75 as illustrated in FIGS. 36 through 37. The climbing worker 150 then grasps the rope grab 170 and the lifeline 50 and pulls on the lifeline 50 to get some of the first portion of lifeline 50 out of the main housing member 122 of the lifeline supply assembly to create slack in the lifeline 50. This is illustrated in FIG. 38. The slack lifeline 50 is then positioned within the carabiner 510 of the support anchor assembly 500 as illustrated in FIG. 39. At this point the mobile lifeline ladder system 100 is ready for use. One benefit of the mobile lifeline ladder system 100 is that the anchoring is to the support structure 80 instead of solely anchoring it to the ladder 75 which could fall down during a fall event.

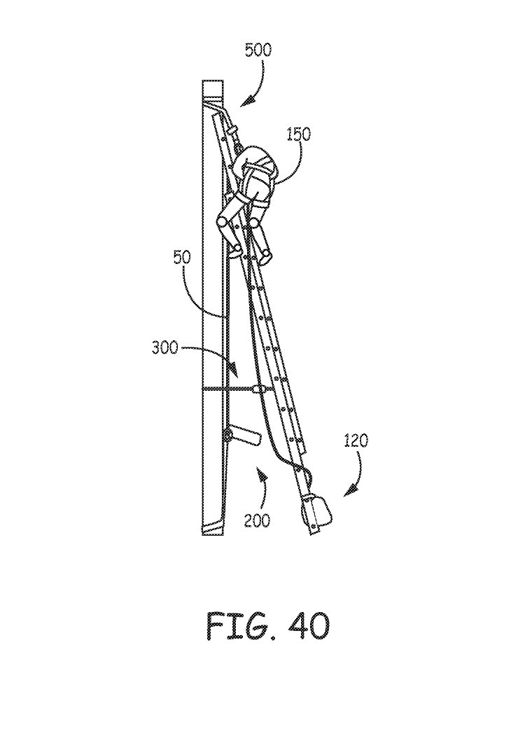

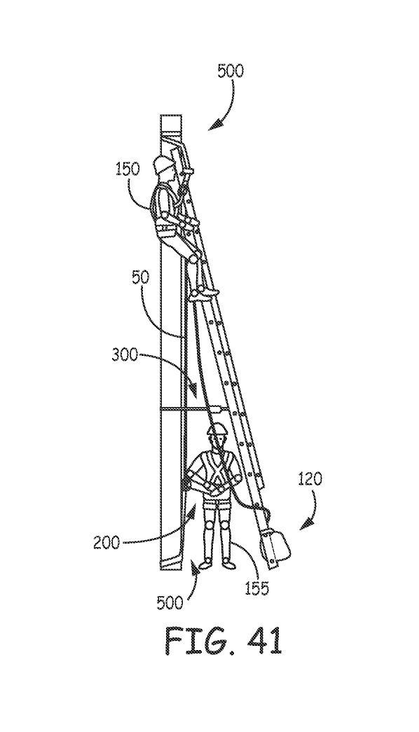

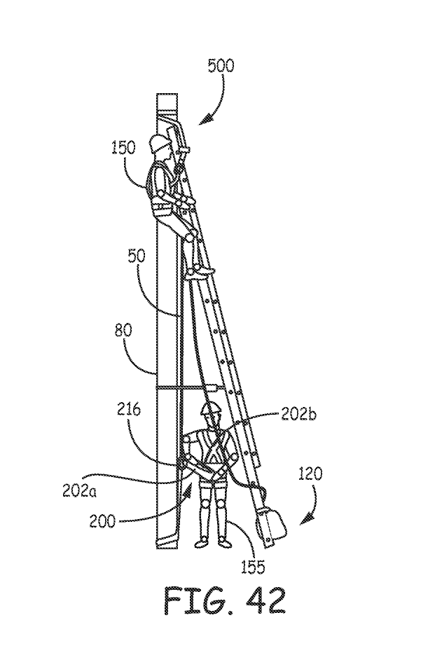

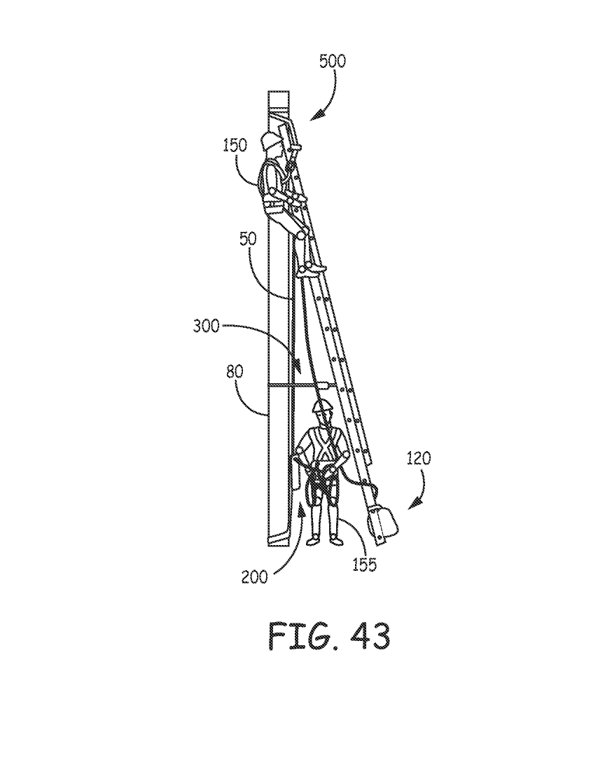

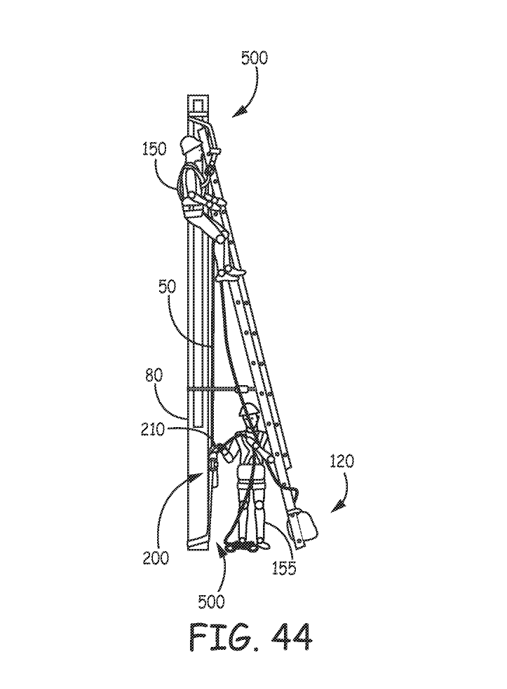

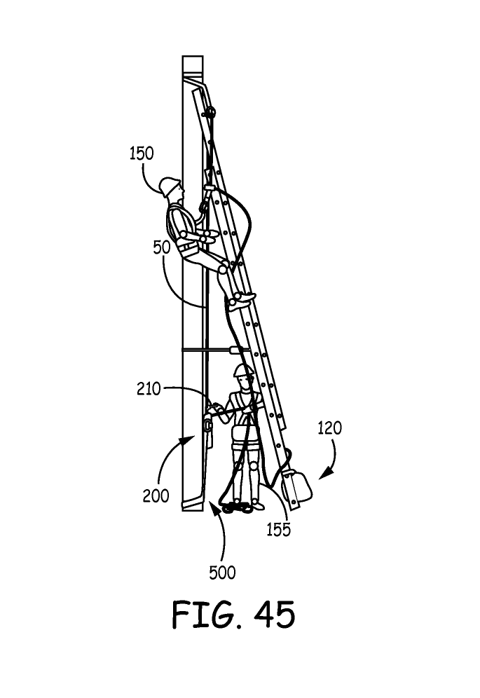

The use of the mobile lifeline ladder system 100 during a fall event is illustrated in FIGS. 40-45. FIG. 40 illustrates the climbing worker 150 experiencing a fall event. As illustrated, the lifeline 50 attached to the rescue assembly 200 is taunt and holding the climbing worker 150 in place. In particular, the lifeline 50 wrapped around the lock member 215 of the lifeline payout regulator 210 and the second lifeline portion held within the rescue case 202 of the rescue assembly 200 prevents the lifeline 50 from moving, to hold the climbing worker 150 in place during a fall event. FIG. 41 illustrates a rescue worker 155 coming to manipulate the rescue assembly 200 to lower the climbing worker 150 with the mobile lifeline ladder system 100. The rescue worker 155 first opens the case 202 of the rescue assembly 200 as illustrated in FIG. 42 and then removes the second portion of the lifeline 50 that was in case 202 as illustrated in FIG. 43. The rescue worker 155 then manipulates the lifeline payout regulator 210 to selectively payout the lifeline 50 as illustrated in FIGS. 44 and 45 until the climbing worker 150 is safely on the ground. In particular, the rescue worker 155 grasps the handle portion 210b of the lifeline payout regulator 210 with a first hand while controlling the payout of the second portion of the lifeline 50 with the worker's second hand. Controlling payout of the lifeline 50 is accomplished by feeding the lifeline 50 into the regulator 210 (this action allows the lifeline 50 to slide around the lock member 215) to allow the lifeline 50 to payout slowly.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A mobile lifeline ladder system comprising:
a lifeline having a first portion, a second portion and an intermediate portion positioned between the first portion and the second portion;
a lifeline supply assembly containing the first portion of the lifeline, the lifeline supply assembly configured and arranged to be coupled to a ladder;
a rescue assembly containing the second portion of the lifeline, the rescue assembly configured and arranged to be coupled to a first support structure, the rescue assembly including a lifeline payout regulator to selectively payout the second portion of the lifeline; and
an anchor assembly configured and arranged to be coupled to a second support structure above the ladder, the intermediate portion of the lifeline slidably held by the anchor assembly.

2. The mobile lifeline ladder system of claim 1 wherein the first support structure is the same as the second support structure.

3. The mobile lifeline ladder system of claim 1, further comprising:
a ladder stabilizing assembly configured and arranged to couple the ladder to a support structure.

4. The mobile lifeline ladder system of claim 3, wherein the support structure is at least one of the first and second support structures.

5. The mobile lifeline ladder system of claim 3, wherein the ladder stabilizer assembly further comprises:
a stabilizer connection strap having a first portion and a second portion; and
a stabilizing case configured and arranged to selectively house the first portion of the connection strap when not in use.

6. The mobile lifeline ladder system of claim 5, further comprising:
a strap connector configured and arranged to couple the first portion of the stabilizer connection strap to the ladder.

7. The mobile lifeline ladder system of claim 1, further comprising:
a ladder anchor assembly configured and arranged to slidably hold the intermediate portion of the lifeline proximate an upper portion of the ladder.

8. The mobile lifeline ladder system of claim 7, wherein the ladder anchor assembly further comprises:
a first anchor strap portion, the first strap portion including,
a first holding loop portion configured to receive a carabiner,
a first connection looped portion configured to be coupled to a rung of the ladder, and
a first connection portion used at least in part to form the holding looped portion and the first connection looped portion;
a second anchor strap portion, the second portion including,
a second holding loop portion configured to receive the carabiner,
a second connection looped portion configured to be coupled to the rung of the ladder, and
a second connection portion used at least in part to form the second holding looped portion and the second connection looped portion; and
a carabiner received within the first holding loop portion of the first anchor strap portion and the second holding loop portion of the second anchor strap portion.

9. The mobile lifeline ladder system of claim 1, wherein the lifeline supply assembly further comprises:
a main housing member having an access portion, the access portion being configured and arranged to have an open position and a closed position, the main housing configured and arranged to hold the lifeline, rescue assembly and the anchor assembly during transport; and
at least one connector strap to couple the main housing member to a rung of the ladder.

10. The mobile lifeline ladder system of claim 1, wherein the rescue assembly further comprises:
a case configured and arranged to selectively hold the second portion of the lifeline;
a carabiner coupled to the lifeline payout regulator; and
a connector link coupled to the carabiner, the lifeline passing through the connector link.

11. The mobile lifeline ladder system of claim 1 wherein the anchor assembly further comprising:
a carabiner;
a main strap portion, the main strap portion having a first end coupled to the carabiner and a second end;
a connection loop portion coupled to the second end of the main strap portion, the connection looped portion configured and arranged to be coupled to the second support structure above the ladder.

12. The mobile lifeline ladder system of claim 1, wherein the lifeline payout regulator further comprises:
a base portion;
a handle portion coupled to the base portion; and
a lock member coupled to a side of the base portion, the lifeline routed around the lock member.

13. The mobile lifeline ladder system of claim 12, wherein the lock member includes at least one corner portion to prevent the lifeline from sliding around the lock member.

14. A mobile lifeline ladder system, comprising:
a lifeline having a first portion, a second portion and an intermediate portion positioned between the first portion and the second portion;
a rescue assembly containing the second portion of the lifeline, the rescue assembly configured and arranged to be coupled to a first support structure, the rescue assembly including a lifeline payout regulator to selectively payout the second portion of the lifeline;
an anchor assembly configured and arranged to be coupled to a second support structure above a ladder, the intermediate portion of the lifeline slidably held by the anchor assembly; and
a lifeline supply assembly including a main housing member, the main housing member configured and arranged to contain the lifeline, the rescue assembly and the anchor assembly during transit, the main housing further configured and arranged to be coupled to the ladder during use while housing the first portion of the lifeline.

15. The mobile lifeline ladder system of claim 14, wherein the lifeline payout regulator further comprises:
a base portion;
a handle portion coupled to the base portion; and
a lock member coupled to a side of the base portion, the lifeline routed around the lock member, the lock member including at least one corner portion to prevent the lifeline from sliding around the lock member.

16. A method of implementing a lifeline ladder system, the method comprising:
coupling a main housing member of a lifeline supply assembly to a ladder proximate a base portion of the ladder;
coupling a support anchor assembly to a first support structure above the ladder, the support anchor including a routing member;
coupling a rescue assembly to a second support structure near the base portion of the ladder, the rescue assembly including a lifeline payout regulator;
routing a lifeline from the main housing, through the routing member of the support anchor and to the rescue assembly; and
attaching a rope grab that is connected to a safety harness donned by a worker to the lifeline.

17. The method of claim 16, further comprising;
removing the support anchor assembly, the rescue assembly and a portion of the lifeline from the main housing member.

18. The method of claim 16, further comprising:
after a fall event, manipulating the lifeline payout regulator to lower the worker.

19. The method of claim 16, further comprising:
coupling a mid-portion of the ladder to a third support with a ladder stabilizing assembly.

20. The method of claim 16, further comprising:
routing the lifeline through a ladder anchor assembly coupled to an upper portion of the ladder.
